(19) United States
(12) Patent Application Publication
(10) Pub. No.: US 2003/0147468 A1
(43) Pub. Date: Aug. 7, 2003

(54) Image data coding apparatus capable of promptly transmitting image data to external memory

(75) Inventors: Tetsuya Matsumura, Hyogo (JP); Satoshi Kumaki, Hyogo (JP); Atsuo Hanami, Hyogo (JP); Hiroshi Segawa, Hyogo (JP)

Correspondence Address: McDERMOTT, WILL & EMERY, 600 13th Street, N.W., Washington, DC, 20005-3096, US

(73) Assignee: MITSUBISHI DENKI KABUSHIKI KAISHA

(21) Appl. No.: 10/263,093

(22) Filed: Oct. 3, 2002

(30) Foreign Application Priority Data
Feb. 1, 2002 (JP) 2002-025727(P)

(51) Int. Cl. H04N 7/12

(52) U.S. Cl. 375/240.16; 375/240.1

(57) ABSTRACT

An image data coding apparatus includes: a memory interface which controls reading/writing of data from/to an external memory; an MPEG2 processing unit for performing a compression-coding process using a first compression ratio; and a coder/decoder which is provided between the MPEG2 processing unit and the memory interface, which performs a compression-coding process using a second compression ratio lower than the first compression ratio on data outputted from an image data coding unit to the external memory, and which performs a decoding process on data outputted from the external memory to the image data coding unit.

### BACKGROUND OF THE INVENTION

1. Field of the Invention

The present invention relates to a configuration of an image data coding apparatus for compressing and coding image data.

2. Description of the Background Art

For a DVD (Digital Versatile Disc) and a D-VHS (Digital-Video Home System) capable of recording and reproducing images and digital audio visual devices such as a digital broadcast transmitter/receiver, MPEG2 (Moving Picture Experts Group 2) as an international standard is employed as an image data compressing method. In an image data coding process based on the MPEG2 standard, a computation amount for compressing image data is enormous and a transfer amount of data between a signal processing device and a memory device is also enormous.

FIG. 9 is a schematic block diagram showing the configuration of a conventional image data coding system 600.

Referring to FIG. 9, an image data coding apparatus 601 in image data coding system 600 has an MPEG2 processing unit 602 for compressing and coding image data, and a memory interface 610 for performing data transfer control. MPEG2 processing unit 602 and memory interface 610 are connected to each other via a bus 608. An external memory 614 such as a general DRAM provided on the outside is connected to memory interface 610 via a bus 612.

MPEG2 processing unit 602 includes: a video signal input/output unit 603 for transmitting/receiving a video signal to/from the outside of image data coding apparatus 601; a motion predicting/compensating unit 604 for predicting a motion and compensating a video signal in MPEG2 coding; a DCT/quantizing unit 605 for performing a discrete cosine transform (DCT) process, a quantizing process, and further, an inverse quantizing/inverse DCT process for motion prediction and compensation; and a variable length coding unit 606 for receiving a signal outputted from DCT/quantizing unit 605, performing variable length coding on the signal, and outputting a resultant signal as a bit stream to the outside of image data coding apparatus 601.

As external memory 614, for example, a dynamic random access memory (hereinbelow, DRAM), particularly, a synchronous DRAM (hereinbelow, SDRAM) placing importance on high processing speed is used. External memory 614 is an image memory for temporarily storing image data in a coding process in a frame or a field and a process such as motion prediction between frames or fields.

To monitor whether image data is coded correctly or not, an encoder decodes coded image data and outputs the result as a video outputted from video signal input/output unit 603.

FIG. 10 is a flowchart showing a data transfer process in a coding process on a frame unit basis of image data coding apparatus 601.

In the following, for simplicity of description, description will be given on assumption that a picture to be processed is a frame image.

Referring to FIG. 10, first, when original image data is inputted as a video inputted to MPEG2 processing unit 602, in video signal input/output unit 603, as a pre-process, a spatial filter process and a time filter process are performed on data. The spatial filter process in this case denotes a process of removing harmonic noise by filtering image signals in the same frame, and the time filter process denotes a process of removing harmonic noise by comparing pixels in a preceding frame and pixels in a subsequent frame.

Original image data subjected to the spatial filter process is stored on a frame unit basis into external memory 614 via bus 608, memory interface 610, and bus 612. In the time filter process, MPEG2 processing unit 602 reads out image data from external memory 614 and compares pixels of a preceding frame with pixels of a subsequent frame, thereby removing harmonic noise.

The original image data subjected to the pre-processing is stored on a frame unit basis into external memory 614 via bus 608, memory interface 610, and bus 612 (step S1f).

After image data of some frames is stored, the data in the frames as images to be coded are re-ordered for a following motion predicting process and the resultant is read by MPEG2 processing unit 602 (step S2f).

In MPEG2 processing unit 602, first, a process of encoding an I frame is performed, and coded information is outputted as a bit stream output (step S7f). The coding process includes discrete cosine transform process, quantizing process, variable length coding process, and the like. In the case of an I frame, intraframe coding is performed, so that a motion searching process is not carried out.

MPEG2 processing unit 602 generates a video outputted for monitoring coded data (step S8f). Since the coded image data is used as a reference image for predicting preceding/subsequent frames, it is also stored as an image (reconstructed image) reconstructed by a series of processes of inverse quantization and inverse DCT process into external memory 614 via bus 608, memory interface 610, and bus 612.

A process of coding a P frame will now be described. First, re-ordered image data is read by the encoder (step S2f). In the case of a P frame, on the basis a reconstructed image of an I or P frame, a motion searching process is performed by motion predicting/compensating unit 604. MPEG2 processing unit 602 constructs a new image (predicated image) on the basis of a motion vector obtained by the motion searching process and, after that, performs coding.

FIG. 10 shows a case where, as an example of the motion searching process, a motion is roughly searched at integer pixel precision and, after that, search is made at half pel (half pixel) precision, thereby determining a motion vector at high precision (steps S3f and S4f). With respect to any of the motion searching processes, the reference image of motion search is an I or P frame. For example, to generate the first P frame, the reconstructed image of the I frame reconstructed as described above is read from external memory 614.

At this time, memory interface 610 reads the image data of the reconstructed image as an reference image (search window data) from external memory 614 and sends it to MPEG2 processing unit 602. The original image of the P frame read from external memory 614 in step S2f is used as a template image as a base to generate a prediction image in motion predicting/compensating unit 604.

MPEG2 processing unit 602 performs the motion searching process by using the template image and search window data to obtain a motion vector.

Subsequently, MPEG2 processing unit 602 generates a prediction image on the basis of the obtained motion vector (step S5f). Since the prediction image is generated on the basis of the I or P frame, for example, in the case of generating the first P frame, the reconstructed image of the I frame is read again from external memory 614.

The generated prediction image is written as a reconstructed image into external memory 614 (step S6f) and, after that, the coding process is performed by MPEG2 processing unit 602. That is, MPEG2 processing unit 602 reads the reconstructed image from external memory 614 (step S2f), encodes the image, and outputs the coded information as a bit stream output (step S7f).

In a manner similar to the case of the I frame, a video output is generated for monitoring the coded data (step S8f). The reconstructed image in external memory 614 is also used as a reference image for predicting the next frame.

In generation of the P frame of the next time on, in place of the reconstructed image of the I frame, data of the reconstructed image of the P frame is read.

A process of coding a B frame will now be described. With respect to the B frame as well, in a manner similar to the P frame, the motion searching process is performed, a new image is constructed on the basis of a motion vector obtained by the motion searching process and, after that, coding is executed. Consequently, the flow in the flowchart of FIG. 10 is similar to that of the case of the P frame.

In the case of the B frame, however, the motion searching process is performed on the basis of not only data of the past but also image data of the future. The number of motion searching processes in step S3f and S4f is therefore larger than that in the case of the P frame. Specifically, with respect to a B frame in the beginning of the coding process where image data of the past does not exist, the motion searching process is performed on the basis of only image data of the future.

When the image coding process is performed, therefore, the kinds of data transfer between MPEG2 processing unit 602 and external memory 614 are mainly as follows.

1) capturing of original image data

(video signal input/output unit→external memory)

2) reading of an image to be coded

(external memory→DCT/quantizing unit)

3) motion search (integer precision search)

(external memory→motion predicting/compensating unit)

4) motion search (half pel search)

(external memory→motion predicting/compensating unit)

5) generation of predicted image

(external memory→motion predicting/compensating unit)

6) writing of reconstructed image

(motion predicting/compensating unit→external memory)

7) writing/reading of coded data

(variable length coding unit→external memory)

8) decoded image

(external memory→motion predicting/compensating unit)

The coding is executed while performing roughly eight kinds of data transfer with the external memory.

FIG. 11 is a conceptual diagram showing an example of memory mapping of external memory 614 in the case of performing such processes.

Data in FIG. 11 is image data of an original image and a reconstructed image which are not compressed. Usually, in MPEG2 coding, the bi-directional predicting process is performed, so that the re-ordering process is necessary as described above. The original images of four frames and, reconstructed images for bi-directional prediction of two frames are stored in external memory (frame memory) 614 and the process is performed. For example, a data amount of one NTSC image is about 4 megabits, so that a frame memory for image storage needs a capacity of 24 megabits. Further, to perform the MPEG2 coding process on image data at a resolution of HDTV of higher picture quality, a memory having a capacity of 256 megabits or larger is necessary.

As shown in FIG. 11, in a storage area AR1, image data #1(Y) of a luminance signal and image data #1(Cb, Cr) of color difference signals of a reconstructed image of a frame is stored. Similarly, in a storage area AR2, image data #2(Y) of a luminance signal and image data #2 (Cb, Cr) of color difference signals of a reconstructed image of another frame is stored.

In storage areas AR3 to AR6 of external memory 614, data #1(Y) and #1(Cb, Cr) to data #4(Y) and #4(Cb, Cr) of inputted original images is stored, respectively. An area other than storage areas AR1 to AR6 and a bit stream area is “available (free)”.

As described above, in the image data coding process conformed with the MPEG2 standard, the computation amount for compressing image data is enormous and an amount of data transfer between a signal processing device (image data coding apparatus 601 in FIG. 9) and a memory device (external memory 614 in FIG. 9) is also enormous.

At the time of processing an enormous amount of data, it is a problem how to construct the image data coding apparatus. In other words, it is a subject in the system configuration of the coding apparatus how to solve performance deterioration (deterioration in a picture quality) due to insufficient computation throughput and insufficient data transferring capability.

In the case of the configuration of the image data coding apparatus shown in FIG. 9, since a memory device such as a general DRAM is employed, the operating speed of input/output pins and the bus width between memory interface 610 and external memory 614 regulate the throughput of data transfer.

In order to transfer image data stored in a memory of a large capacity efficiently and promptly, it is desired to increase the speed of operation in input/output pins and widen the bus width. However, in the case of using a memory device such as a general DRAM, such a desire cannot be promptly realized.

Since the amount of data transfer with the outside is enormous, power consumption for the data inputting/outputting operation is high, which is a critical problem, particularly, for use in a battery-operated portable device.

### SUMMARY OF THE INVENTION

An object of the invention is to provide an image data coding apparatus capable of efficiently and promptly transferring image data.

The invention provides, in short, an image data coding apparatus including a memory interface; an image data coding unit; and a coding/decoding unit.

The memory interface can be connected to an external memory and controls reading/writing of data from/to the external memory. The image data coding unit receives successive plural pieces of image data, performs a motion searching process on the image data to generate a prediction image, and performs a compression-coding process on the image data by using the prediction image. The coding/decoding unit is provided between the image data coding unit and the memory interface, performs compression-coding on data outputted from the image data coding unit to the external memory, and performs decoding process on data outputted from the external memory to the image data coding unit.

Therefore, an advantage of the invention is that, by performing image coding when image data is stored into an external memory and by performing image decoding when the image data is read from the external memory, the data amount can be reduced. Since the compression ratio of the image coding/decoding in the case of accessing the external memory is sufficiently lower than that of inherent image coding, deterioration in picture quality caused by the coding for access does not exert an influence on deterioration in picture quality caused by inherent image coding. That is, data transfer with the external memory can be reduced while suppressing deterioration in picture quality.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic block diagram showing the configuration of an image data coding system 100 of a first embodiment of the invention;

FIG. 2 is a block diagram of a coder/decoder 107 in FIG. 1;

FIG. 3 is a conceptual diagram showing a state where compressed image data is stored as a bit stream in an image data area in an external memory 111;

FIG. 4 is a conceptual diagram showing a storage state of the bit stream stored in a bit stream area in a reconstructed image;

FIG. 5 is a diagram showing the storage state of the compressed bit stream conceptually shown in FIG. 4 as an actual memory image;

FIG. 6 is a schematic block diagram showing the configuration of an image data coding apparatus 601 in a second embodiment;

FIG. 7 is a schematic block diagram showing the configuration of image data coding apparatus 601 in the second embodiment;

FIG. 8 is a schematic block diagram for explaining the configuration of an image data coding apparatus 501 of a fifth embodiment of the invention;

FIG. 9 is a schematic block diagram showing the configuration of a conventional image data coding system 600;

FIG. 10 is a flowchart showing a data transferring process in a coding process on a frame unit basis of image data coding apparatus 601; and

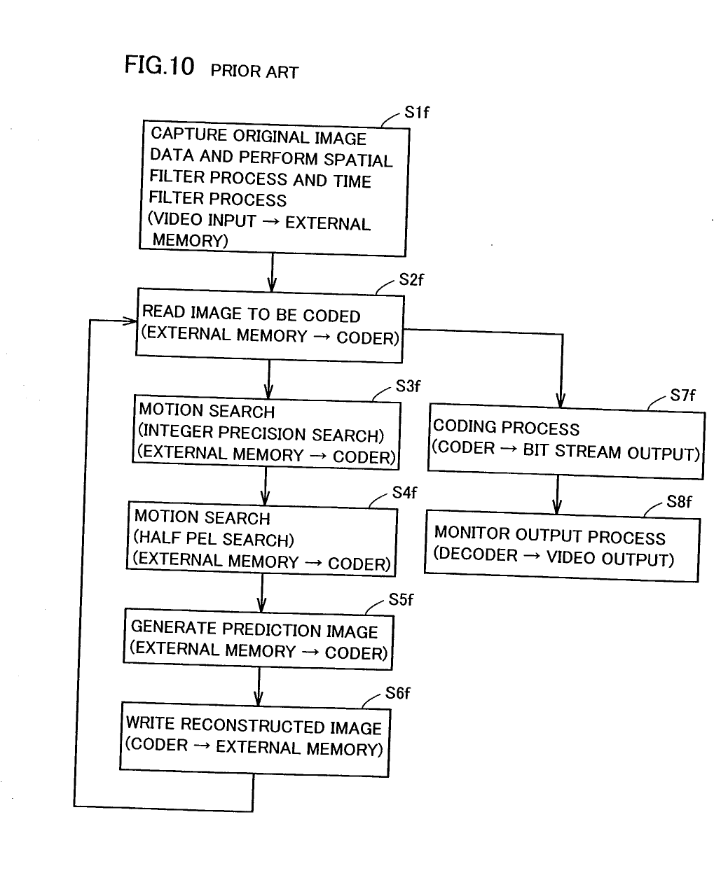

FIG. 11 is a conceptual diagram showing an example of memory mapping of an external memory 614.

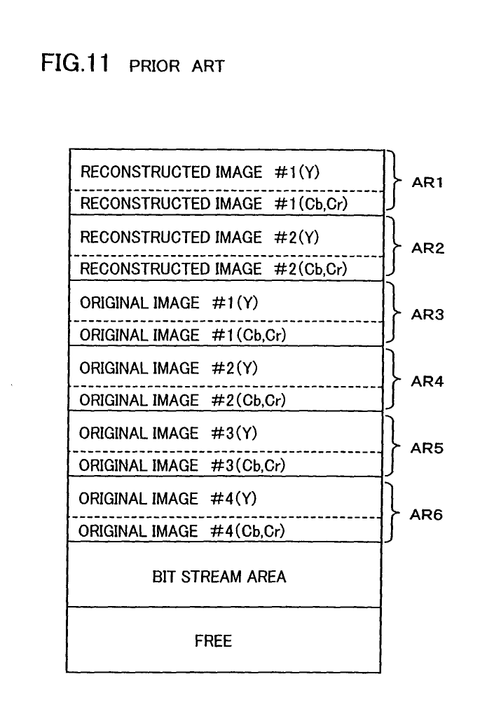

### DESCRIPTION OF THE PREFERRED EMBODIMENTS

Embodiments of the invention will be described hereinbelow with reference to the drawings. The same components in the drawings are designated by the same reference numerals and the description will not be repeated.

In the following description, with respect to an amount of information to be compressed, “compression ratio” denotes a ratio between an amount of information before a compressing process and an amount of information after the compressing process, that is, (an information amount after process)/(an information amount before process). A high compression ratio means that the information amount after process is much lower than the information amount before process.

### First Embodiment

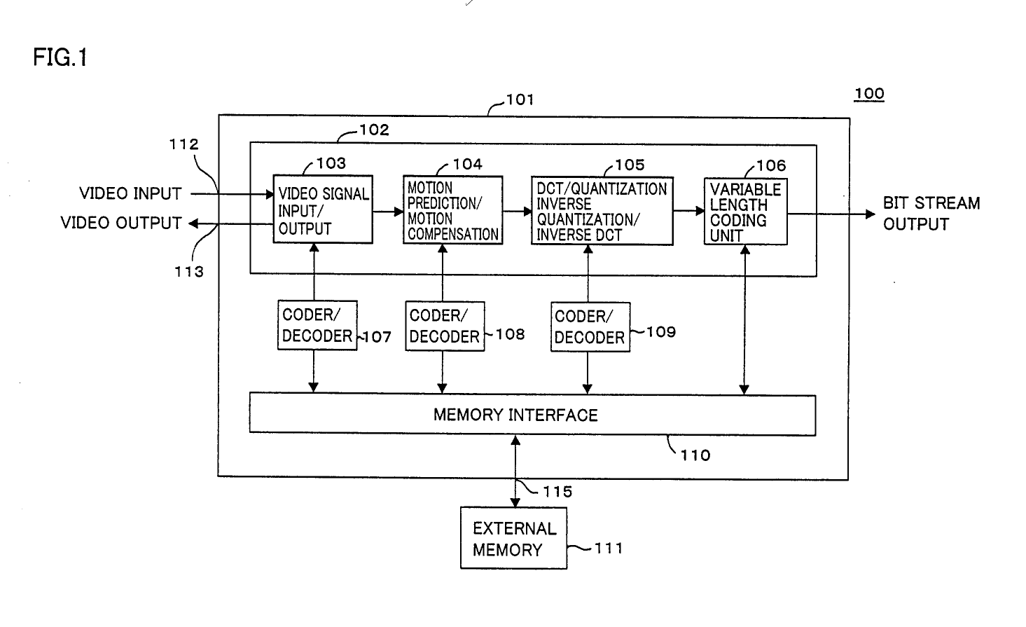

FIG. 1 is a schematic block diagram showing the configuration of an image data coding system 100 of a first embodiment of the invention.

Referring to FIG. 1, an image data coding apparatus 101 in image data coding system 100 is a coding LSI conformed with MPEG2.

Image data coding apparatus 101 has an MPEG2 encoder 102, a memory interface 110, and three coders/decoders 107, 108, and 109.

Further, MPEG2 encoder 102 has a video signal input/output unit 103, a motion predicting/compensating unit 104, a DCT/quantizing unit 105, and a variable length coding unit 106.

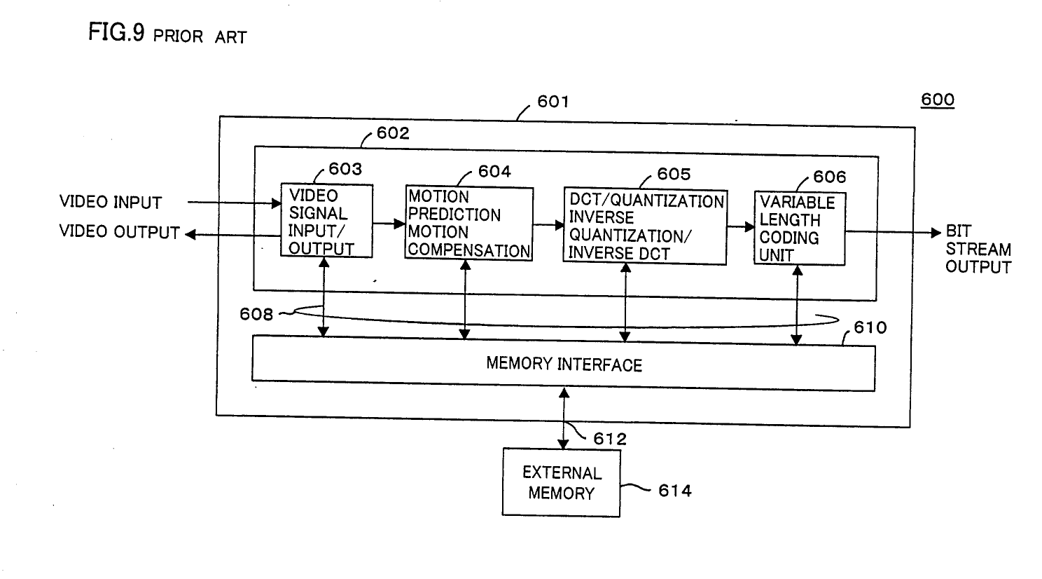

Processes performed by functional blocks of video signal input/output unit 103, motion predicting/compensating unit 104, DCT/quantizing unit 105, and variable length coding unit 106 are basically similar to those performed by video signal input/output unit 603, motion predicting/compensating unit 604, DCT/quantizing unit 605, and variable length coding unit 606 in MPEG2 encoder 602 shown in FIG. 9.

Further, video signal input/output unit 103, motion predicting/compensating unit 104, DCT/quantizing unit 105, and variable length coding unit 106 execute coding while writing/reading data to/from an external memory 111 on a functional block unit basis. Between video signal input/output unit 103, motion predicting/compensating unit 104, and DCT/quantizing unit 105, and memory interface 110, coders/decoders 107, 108, and 109 are connected, respectively. Coders/decoders 107, 108, and 109 reduce an amount of data written/read to/from external memory 111, and restore the reduced data to original image data. Image data coding apparatus 101 as a coding LSI has four kinds of input/output ports (pins) of a video input port 112, a video output port 113, a bit stream output port 114, and a memory port 115.

As the I/O bit width of external memory 111, due to regulation of a general number of pins of an LSI (the number of I/O pins), in practice, widths of 16 bits, 32 bits, 64 bits, and the like are used.

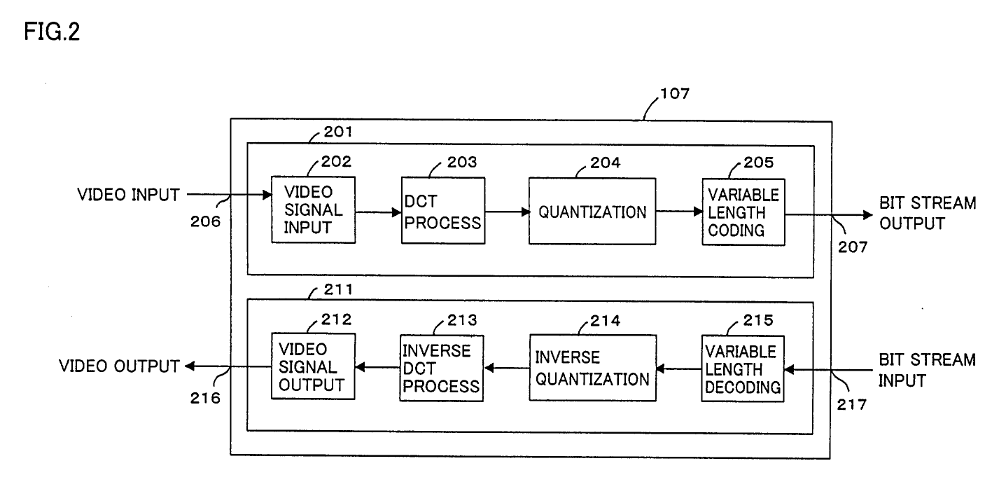

FIG. 2 is a block diagram of coder/decoder 107 in FIG. 1. The configuration of each of the other coders/decoders 108 and 109 is basically similar to that of coder/decoder 107.

Referring to FIG. 2, coder/decoder 107 has an encoder 201 for performing coding only in a frame and a decoder 211. As a “method of performing encoding only in a frame”, for example, I frame coding and decoding of MPEG2 may be used. As another “method of performing encoding only in a frame”, for example, JPEG (Joint Photographic coding Experts Group) may be used.

Encoder 210 has a video signal input unit 202, a DCT unit 203, a quantizing unit 204, and a variable length coding unit 205. A video input node 206 is a node to which an image to video signal input unit 202 is inputted, and a video stream output node 207 is a node from which a bit stream from variable length coding unit 205 is outputted.

Decoder 211 has a variable length decoding unit 215, an inverse quantizing unit 214, an inverse DCT unit 213, and a video output unit 212. A bit stream input node 217 is a bit stream input node to variable length decoding unit 215, and a video output node 216 is a node from which an image from video output unit 212 is outputted.

In the following, a coding procedure using the configuration of the invention of FIG. 1 will be described on the basis of the data transferring operation.

A digitized video signal (for example, in the ITU-R-656 format) is inputted, first, to video signal input/output unit 103. After that, the video signal is subjected to I frame coding of the MPEG2 by coder/decoder 107, and written in the original image bit stream area on external memory 111. Since the original image is already compressed by encoder 201 in FIG. 2, the amount of data actually written is reduced depending on the compression ratio. For example, the data amount can be reduced to 1/2 to 1/10, so that the data transfer amount can be also reduced at the same ratio. In FIG. 2, the compressing operation is executed on a macro block unit basis sequentially by DCT unit 203, quantizing unit 204, and variable length coding unit 205. After that, the original image bit stream is re-ordered and coded in a picture type called an I picture, a P picture, or a B picture.

As an example of explaining data transfer, a sequence of encoding the P picture or B picture requiring transfer of all of data will be explained.

A template image for motion search is read out from external memory 111 via memory interface 110. Since the format on external memory 111 is a compressed bit stream, the compressed bit stream is decoded by coder/decoder 107, and the resultant is transferred to motion predicting/compensating unit 104 and DCT/quantizing unit 105.

In motion predicting/compensating unit 104, simultaneously, a bit stream of a necessary area is transferred as a search window from a preliminarily written reconstructed image bit stream area in external memory 111 and decoded by coder/decoder 108, thereby receiving the resultant as search window data.

After that, a reference image corresponding to an optimum motion vector obtained by motion predicting/compensating unit 104 and an image to be coded are read from external memory 111 via coder/decoder 109, and a differential image is supplied to DCT/quantizing unit 105.

Subsequently, a DCT process and a quantizing process are executed and, after that, a variable length coding process is performed. Finally, the resultant is outputted as a bit stream.

Such a coding operation is executed in practice on assumption that an operation of coding each of I, P, and B frames is according to the picture sequence.

The kinds of data transfer and data transfer paths in the above coding process are summarized as follows.

1) capture of original image data

video signal input/output unit 103→coder/decoder 107→external memory 111

2) reading of image to be coded

external memory 111→coder/decoder 109→DCT/quantizing unit 105

3) motion search (integer precision search)

external memory 111→coder/decoder 108→motion predicting/compensating unit 104

4) motion search (half pel search)

external memory 111→coder/decoder 108→motion predicting/compensating unit 104

5) generation of predication image

external memory 111→coder/decoder 108→motion predicting/compensating unit 104

6) writing of reconstructed image

motion predicting/compensating unit 104→coder/decoder 108→external memory 111

7) writing/reading of coded data

external memory 111→variable length coder 106

8) decoded image

external memory 111→coder/decoder 108→motion predicting/compensating unit 104

The coding and decoding processes performed at the time of transfer of data of external memory 111 are performed on the macro block unit basis and a fixed code length is used in each macro block.

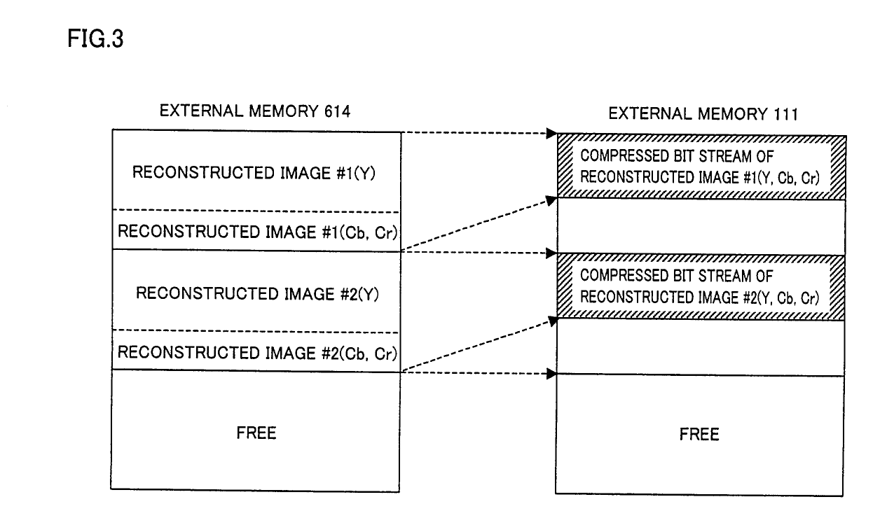

FIG. 3 is a conceptual diagram showing a state where compressed image data is stored as a bit stream in the image data area on external memory 111.

FIG. 3 shows, for comparison, a storage state in conventional external memory 614 and a storage state in external memory 111. For example, for a bit stream of a reconstructed image #1, a part (proportional to the compression ratio) of the conventional area is used as a bit stream area. Therefore, an area which becomes newly free in external memory 111 can be used for other purposes.

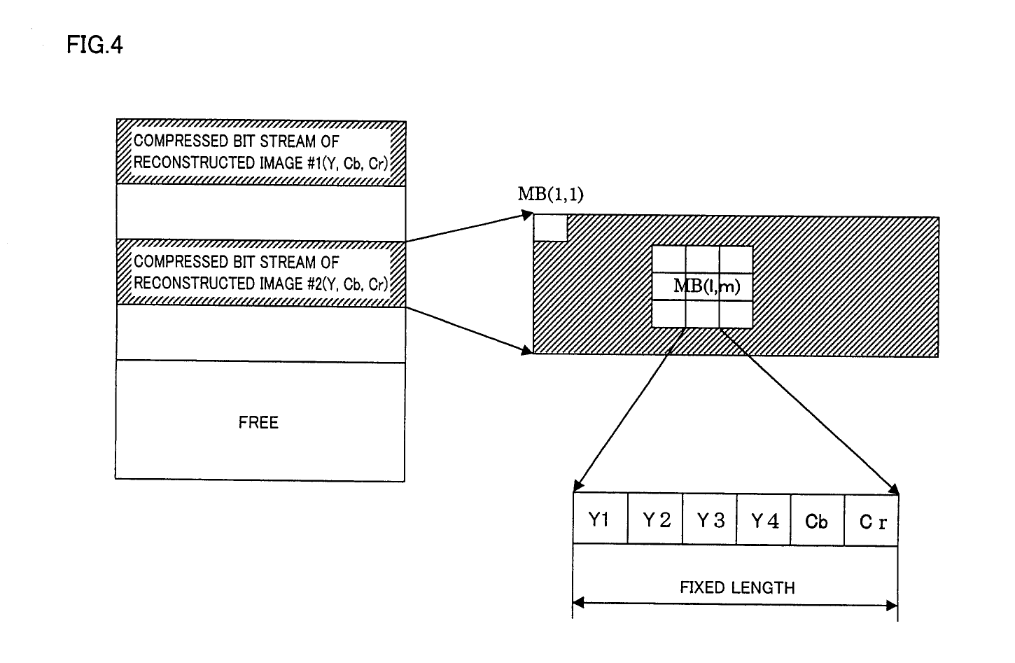

FIG. 4 is a conceptual diagram showing a storage state of a bit stream stored in the bit stream area in the reconstructed image. The compressed bit stream is quantized so as to be in the fixed length on the macro block unit basis.

Specifically, compression data (Y1 to Y4, Cb, and Cr) of a macro block MB(l, m) (l, m: natural numbers) is stored in the format of a bit stream into external memory 111. FIG. 4 shows a case where the ratio between the number of pixels corresponding to luminance signals Y and the number of pixels corresponding to each of two color difference signals Cb and Cr is 4:1.

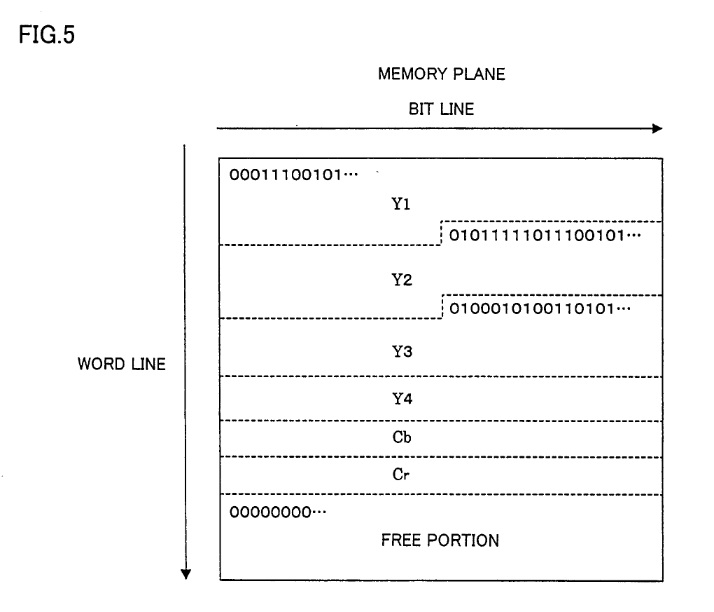

FIG. 5 is a diagram showing a storage state of the compressed bit stream conceptually illustrated in FIG. 4 as an actual memory image.

As shown in FIG. 5, in a memory plane, areas for storing luminance signals Y1 to Y4 and color difference signals Cb and Cr are provided. In each area, a memory area (bit line×word line) assigned to each macro block has a fixed size.

Specifically, the information amount of the macro block is subjected to quantization control so as to be in a fixed length. Although in a state of a bit stream, in the memory space of external memory 111, storage data is mapped two-dimensionally on the macro block unit basis.

By storing data in such a format into external memory 111, even in a bit stream format, two-dimensional addressing can be easily performed on the macro block unit basis.

Consequently, in particular, search window transfer in motion prediction and generation of image data at the time of generating a reference image by an obtained motion vector can be easily realized. In generation of a reference image, in practice, a bit stream is transferred and decoded by a coder/decoder, thereby assuring an image area necessary for generation of the reference image in external memory 111.

Usually, in the fields to which an MPEG2 coding device is applied, a bit rate of about 4 Mbps to 6 Mbps is used. Therefore, a final image compression ratio, that is, the ratio between an information amount of an input image of the coding apparatus and an information amount of an output image is 1/20 to 1/30. However, by setting the compression ratio of each of coders/decoders 107 to 109 disposed between the units and memory interface to be sufficiently low, deterioration in picture quality is extremely reduced as compared with deterioration in picture quality in inherent coding, and the same kind of coding method based on DCT is employed. Thus, without exerting an influence on the picture quality of an entire image, a coding sequence can be realized. For example, it is sufficient to set the compression ratio of each of coders/decoders 107 to 109 to about 1/2 to 1/10.

At this time, memory traffic is reduced by an amount corresponding to the compression ratio used to compress an image in each of coders/decoders 107 to 109. Thus, in the MPEG2 coding apparatus conventionally requiring an enormous data transfer amount, not only lower cost because of reduction in the memory capacity but also lower power consumption because of reduction in bus traffic can be realized.

### Second Embodiment

The first embodiment relates to the configuration in which coders/decoders 107, 108, and 109 are connected between video signal input/output unit 103, motion predicting/compensating unit 104, and DCT/quantizing unit 105 and memory interface 110, respectively.

In a second embodiment, in the configuration and coding operation of the first embodiment, at least one of coders/decoders 107 to 109 corresponding to video signal input/output unit 103, motion predicting/compensating unit 104, and DCT/quantizing unit 105, respectively, is selectively provided.

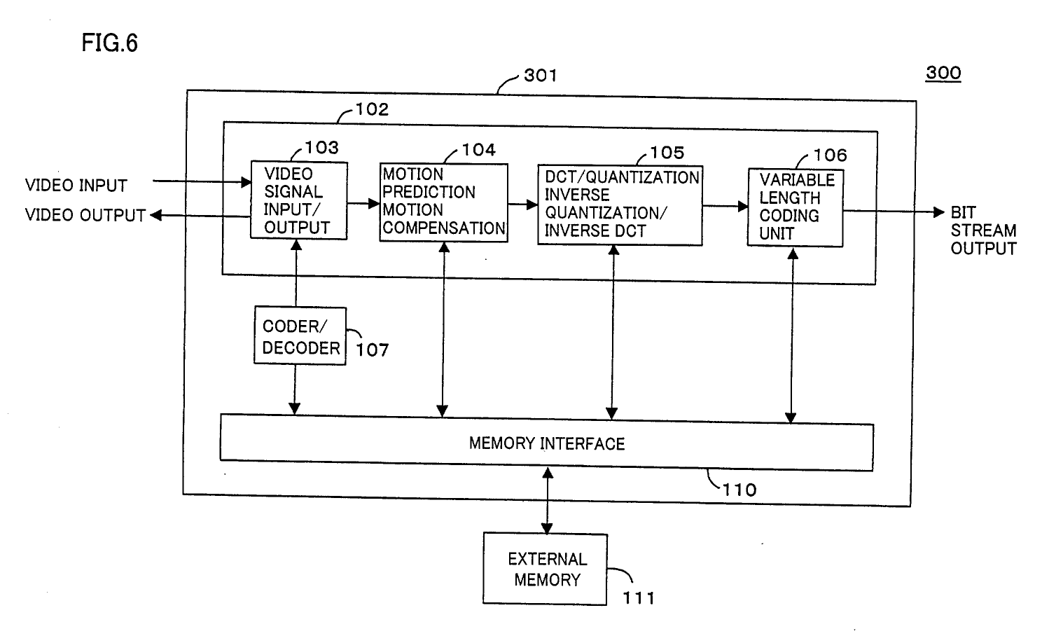

FIG. 6 is a schematic block diagram showing the configuration of image data coding apparatus 601 of the second embodiment.

In image data coding apparatus 601, only in the case of storing an original image, image data is compressed by coder/decoder 107 and the compressed data is stored.

With such a configuration, as compared with the configuration of the first embodiment, the data transfer amount and the used memory area are larger. However, since it is unnecessary to mount coders/decoders 108 and 109, the hardware scale can be reduced.

In addition, since it is unnecessary to carry out coding and decoding as factors of picture quality deterioration by an amount corresponding to the processes of coders/decoders 108 and 109, higher picture quality can be achieved.

Similarly, in the configuration of image data coding apparatus 101 of the first embodiment, only coder/decoder 108 or 109 can be mounted.

A configuration of the coding apparatus having two coders/decoders out of three coders/decoders 107 to 109 can be also employed.

### Third Embodiment

In an image data coding apparatus of a third embodiment, in the configuration and coding operation of image data coding apparatus 101 of the first embodiment, in coders/decoders 107 to 109 corresponding to video signal input/output unit 103, motion predicting/compensating unit 104, and DCT/quantizing unit 105, the compression ratio in each of coders/decoders 107 to 109 is selectively changed according to a coding picture type.

Specifically, the compression ratio is selectively changed according to the picture type of I picture, P picture, or B picture, thereby increasing the compression efficiency.

Concretely, a quantizing step of quantizing unit 204 in FIG. 2 is controlled by using a picture type as a parameter.

Usually, the B picture is not used as a prediction image used at the time of coding other picture, even if the compression ratio is increased a little (that is, picture quality deteriorates), there may be no problem in actual use. Therefore, increase in compression ratio of the B picture is effective at reducing cost by reduction in the memory capacity and at lowering power consumption by reduction in bus traffic.

### Fourth Embodiment

In an image data coding apparatus of a fourth embodiment, in the configuration and coding operation of image data coding apparatus 101 of the first embodiment, in coders/decoders 107 to 109 corresponding to video signal input/output unit 103, motion predicting/compensating unit 104, and DCT/quantizing unit 105, the compression ratio in each of coders/decoders 107 to 109 is selectively changed according to a result of an image pre-process.

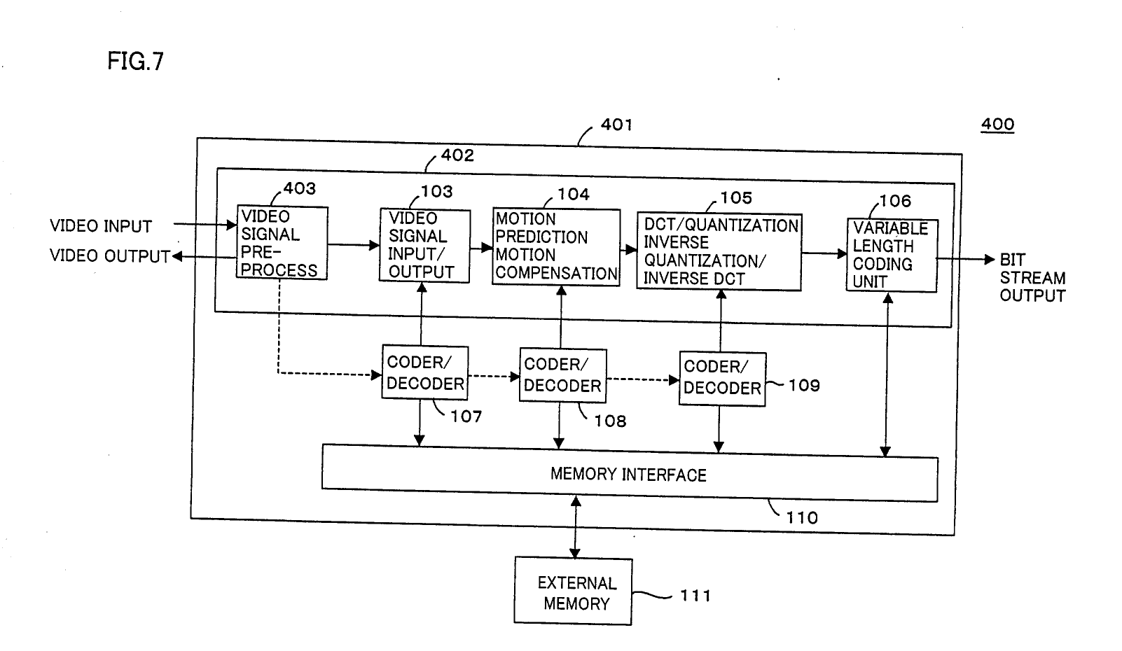

FIG. 7 is a schematic block diagram showing the configuration of image data coding apparatus 601 of the second embodiment. A video signal pre-processing unit 403 for receiving a video signal and performing a pre-process on the video signal is further provided for the configuration of image data coding apparatus 101 of the first embodiment. Further, according to an instruction from video signal pre-processing unit 403, the compression ratios in coders/decoders 107 to 109 are changed.

Specifically, by selectively changing the compression ratio in accordance with inherent characteristics (characteristic parameters) of an image such as the presence or absence of averaging, dispersion, and a motion, and the presence or absence of a scene change, the compression ratio can be increased. Concretely, the quantizing step of quantizing unit 204 in FIG. 2 is controlled by using a result of an image pre-process as a parameter. For example, since a plane image does not include many high frequency components, even if the compression ratio is increased a little, an influence is hardly exerted on the picture quality. On the contrary, a high precision image includes many high frequency components, so that if the compression ratio is increased, an influence is largely exerted on picture quality. By determining such a property by the image pre-process, the compression ratio is controlled.

With such a configuration, therefore, both lower cost by reducing the memory capacity and lower power consumption by reducing bus traffic can be realized while maintaining the picture quality.

### Fifth Embodiment

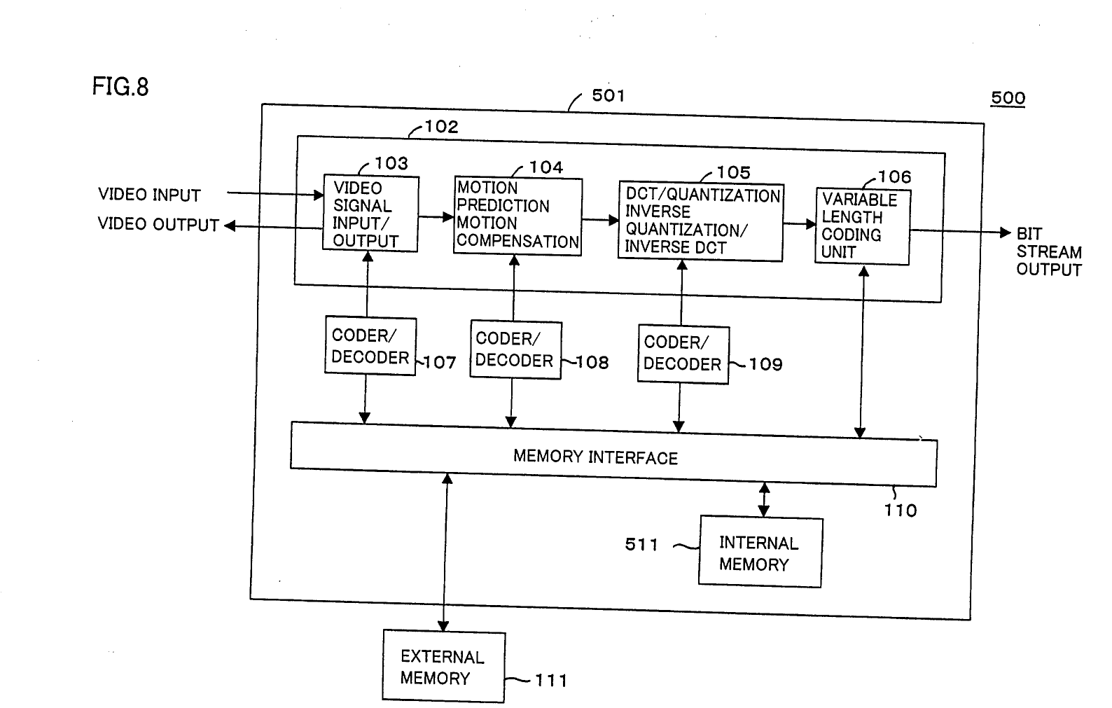

FIG. 8 is a schematic block diagram for explaining the configuration of an image data coding apparatus 501 of a fifth embodiment of the invention.

Image data coding apparatus 501 of the fifth embodiment has a configuration that a part or all of the bit stream area of an original image or reconstructed image in external memory 111 is stored in an LSI chip as a component of image data coding apparatus 501. Consequently, an internal memory 511 capable of transferring data to/from video signal input/output unit 103, motion predicting/compensating unit 104, DCT/quantizing unit 105, and variable length coding unit 106 via memory interface 110 can be integrated in image data coding apparatus 501.

Internal memory 511 is, for example, an area for storing a bit stream of a reconstructed image used for the motion predicting process.

Usually, the memory capacity of one reconstructed image is about 4 MB, and a memory area for storing two images requires 8 MB. However, a bit stream obtained by compressing a reconstructed image is stored in internal memory 511, so that a memory capacity of, for example, 2 MB or less can be realized.

In other words, in the fifth embodiment, an embedded chip on which a memory device and a signal processing device (logic device) are mounted is used as an image data coding apparatus. In the image data coding apparatus, limitation of data transfer throughput due to employment of an external memory is a little, and image data can be efficiently and promptly transferred.

In the case of the embedded chip, the logic part and the memory part can be connected to each other with a wide bus width, so that the throughput of data transfer can be improved. However, the capacity of the memory part in the embedded chip is smaller than that of a general DRAM. If the capacity is increased, it causes increase in the chip size, and the cost becomes higher.

In the configuration shown in FIG. 8, therefore, as a memory necessary for the coding process and the motion searching process, an external memory connected on the outside and the internal memory on the embedded chip are properly used as necessary.

Specifically, in the case of a process in which data transfer is the bottleneck, image data is transferred to/from the internal memory capable of transferring data at high speed. In the case of a process which does not particularly require high-speed data transfer, image data is transferred to/from the external memory.

With such a configuration as well, lower cost by reducing the memory capacity and lower power consumption by reducing the bus traffic can be realized while maintaining picture quality.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image data coding apparatus comprising:
a memory interface which can be connected to an external memory and which controls reading/writing of data from/to said external memory;
an image data coding unit to which successive plural pieces of image data are inputted, which performs a motion searching process on said image data to generate a prediction image, and which performs a compression-coding process on said image data by using said prediction image; and
a coding/decoding unit which is provided between said image data coding unit and said memory interface, which performs compression-coding on data outputted from said image data coding unit to said external memory and which performs decoding process on data outputted from said external memory to said image data coding unit.

2. The image data coding apparatus according to claim 1, wherein
said coding/decoding unit includes:
a coder for performing coding on the basis of only data in a plane to be processed; and
a decoder for decoding data in said plane to be processed from the coded data.

3. The image data coding apparatus according to claim 1, wherein
said image data coding unit includes:
a video signal input/output unit for receiving a video signal inputted to said image data coding apparatus and writing the video signal into said external memory via said memory interface;
a motion predicting/compensating unit for performing said motion searching process and a motion compensating process in a compression-coding process on said image data; and
a transforming unit for performing discrete cosine transform and a quantizing process on an output of said motion predicting/compensating unit and generating a reconstructed image for said motion compensating process, and
said coding/decoding unit includes:
a first coder/decoder provided between said video signal input/output unit and said memory interface;
a second coder/decoder provided between said motion predicting/compensating unit and said memory interface; and
a third coder/decoder provided between said transforming unit and said memory interface.

4. The image data coding apparatus according to claim 1, wherein
said image data coding unit includes:
a video signal input/output unit for receiving a video signal inputted to said image data coding apparatus and writing the video signal to said external memory via said memory interface;
a motion predicting/compensating unit for performing said motion searching process and motion compensating process in a compression-coding process on said image data; and
a transforming unit for performing discrete cosine transform and a quantizing process on an output of said motion predicting/compensating unit and generating a reconstructed image for said motion compensating process, and
said coding/decoding unit includes
at least one coder/decoder provided either between said video signal input/output unit and said memory interface, between said motion predicting/compensating unit and said memory interface, or between said transforming unit and said memory interface.

5. The image data coding apparatus according to claim 1, wherein
said coding/decoding unit includes means for varying a compression ratio of said compression-coding in accordance with a picture type of image data to be processed.

6. The image data coding apparatus according to claim 1, wherein
said coding/decoding unit includes pre-processing means for extracting a characteristic parameter of a video signal inputted to said image data coding apparatus, and
said coding/decoding unit includes means for varying a compression ratio of said compression-coding in accordance with said characteristic parameter of image data to be processed.

7. The image data coding apparatus according to claim 6, wherein
said characteristic parameter includes at least one information of the presence or absence of averaging, dispersion or a motion of an image, and information of the presence or absence of a scene change.

8. The image data coding apparatus according to claim 1, further comprising an internal memory, wherein
said memory interface is connected to said internal memory and controls reading/writing of data from/to said internal memory, and
said image data used for a reference image of said motion searching process is written into said internal memory via said memory interface.

9. The image data coding apparatus according to claim 1, wherein
the compression ratio of said compression coding performed by said coding/decoding unit is lower than the compression ratio of said compression coding performed by said image data coding unit.
